(19) United States
(12) Patent Application Publication
(10) Pub. No.: US 2016/0281032 A1
(43) Pub. Date: Sep. 29, 2016

(54) DETERGENT CONTAINING METHYL ESTER SULFONATES (MES) AND METHYL ESTER ETHOXYLATES (MEE)

(71) Applicant: Henkel AG & Co. KGaA, Duesseldorf (DE)

(72) Inventors: Inga Kerstin Vockenroth, Duesseldorf (DE); Andreas Buhl, Langenfeld (DE)

(73) Assignee: Henkel AG & Co. KGaA, Duesseldorf (DE)

(21) Appl. No.: 15/178,974

(22) Filed: Jun. 10, 2016

Related U.S. Application Data
(63) Continuation of application No. PCT/EP2014/077054, filed on Dec. 9, 2014.

(30) Foreign Application Priority Data
Dec. 17, 2013 (DE) 10 2013 226 260.4

(51) Int. Cl. C11D 1/83; C11D 11/00; C11D 1/28; C11D 17/04; C11D 1/66

(52) U.S. Cl. CPC C11D 1/83; C11D 17/043; C11D 1/667; C11D 1/28; C11D 11/0017

(57) ABSTRACT

The present invention relates to a detergent, preferably a liquid detergent, containing a surfactant system, which comprises: a) 15 to 50% by weight, based on the surfactant system, of at least one surfactant of the formula: R1-CH(SO3-X+)-C(═O)OCH3; and/or b) 15 to 50% by weight of at least one surfactant of the formula: R2-C(═O)O—(AO)n-CH3, wherein R1, R2, AO, n and X+ are defined as disclosed here. The invention further relates to washing processes which use said detergents and to the use of the surfactant system described here for improving the cleaning power of a detergent.

### FIELD OF THE INVENTION

The present invention generally relates to a detergent having improved cleaning performance, in particular on fatty, oily soiling and/or at low temperatures, and to methods for improving the cleaning performance of a detergent.

### BACKGROUND OF THE INVENTION

The use of different surfactants in detergents is established in the prior art. Used as substances providing washing action, they are employed to increase the solubility of fat and dirt particles adhering to the laundry in water. The performance of such agents on fatty soiling, however, decreases drastically when the temperature is lowered, and the soiling is not removed, or only inadequately, at temperatures below their melting point, resulting in dissatisfaction on the part of the consumer. Moreover, modern textiles are generally sensitive to higher temperatures, so that washing at low temperatures is increasingly gaining in importance. This trend is promoted by increasing ecological awareness and energy savings efforts, since lower washing temperatures mean lower power consumption and reduced CO₂ emissions.

Given the inadequate cleaning performance of most detergents on fatty soiling, such soils are often pretreated; however, this is likewise not very user-friendly. As a result, a general endeavor exists to further optimize the cleaning performance of detergents, in particular on fatty, oily soiling.

It is therefore the object of the present invention to provide a detergent having improved cleaning performance, in particular on fatty, oily soiling, at low temperatures, and a sustainable surfactant mixture.

Surprisingly, it was found that the use of a surfactant system based on methyl esters, in particular on methyl ester ethoxylates (MEE), methyl ester sulfonates (MES) or mixtures thereof, results in an increase in the cleaning performance of detergents, in particular the cleaning performance on fatty, oily soiling, even at low temperatures.

Furthermore, other desirable features and characteristics of the present invention will become apparent from the subsequent detailed description of the invention and the appended claims, taken in conjunction with this background of the invention.

### BRIEF SUMMARY OF THE INVENTION

A detergent, preferably a liquid detergent, including a surfactant system that comprises: 15 to 50 wt. %, preferably 25 to 35 wt. %, each based on the surfactant system, of at least one surfactant of formula R¹—CH(SO₃⁻X⁺)—C(═O)OCH₃; and/or 15 to 50 wt. %, preferably 25 to 35 wt. %, each based on the surfactant system, of at least one surfactant of formula R²—C(═O)O-(AO)ₙ—CH₃, where R¹, R², independently of one another, denote a linear or branched, substituted or unsubstituted alkyl group having 2 to 20 carbon atoms, a linear or branched, substituted or unsubstituted aryl group having 6 to 22 carbon atoms, or a linear or branched, substituted or unsubstituted alkylaryl group having 6 to 22 carbon atoms; AO denotes an ethylene oxide (EO) or propylene oxide (PO) grouping; n denotes an integer from 1 to 50; and X⁺ denotes a monovalent cation or the nth part of an n-valent cation.

Use of a surfactant system for increasing the cleaning performance, in particular on fatty soiling, of a detergent, in particular of a liquid detergent, wherein the surfactant mixture based on the surfactant system comprises: 15 to 50 wt. %, in particular 25 to 35 wt. %, of at least one surfactant of formula R¹—CH(SO₃⁻X⁺)—C(═O)OCH₃; and/or 15 to 50 wt. %, in particular 25 to 35 wt. %, of at least one surfactant of formula R²—C(═O)O-(AO)ₙ—CH₃, wherein R1, R², independently of one another, denote a linear or branched, substituted or unsubstituted alkyl group having 2 to 20 carbon atoms, a linear or branched, substituted or unsubstituted aryl group having 6 to 22 carbon atoms, or a linear or branched, substituted or unsubstituted alkylaryl group having 6 to 22 carbon atoms; AO denotes an ethylene oxide (EO) or propylene oxide (PO) grouping; n denotes an integer from 1 to 50; and X⁺ denotes a monovalent cation or the nth part of an n-valent cation.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In a first aspect, the present invention is directed to a detergent, preferably a liquid detergent, containing a surfactant system that comprises:
a) 15 to 50 wt. %, preferably 25 to 35 wt. %, each based on the surfactant system, of at least one surfactant of formula R¹—CH(SO₃⁻X⁺)—C(═O)OCH₃ and/or
b) 15 to 50 wt. %, preferably 25 to 35 wt. %, each based on the surfactant system, of at least one surfactant of formula R²—C(═O)O-(AO)ₙ—CH₃,
where
R¹, R², independently of one another, denote a linear or branched, substituted or unsubstituted alkyl group having 2 to 20 carbon atoms, a linear or branched, substituted or unsubstituted aryl group having 6 to 22 carbon atoms, or a linear or branched, substituted or unsubstituted alkylaryl group having 6 to 22 carbon atoms,
AO denotes an ethylene oxide (EO) or propylene oxide (PO) grouping,
n denotes an integer from 1 to 50,
X⁺ denotes a monovalent cation or the nth part of an n-valent cation.

In a further aspect, the invention is directed to a washing method comprising the following method steps:
a) providing a washing solution comprising a detergent as defined above, and
b) bringing a textile in contact with the washing solution according to (a).

In still another aspect, the present invention relates to the use of such a detergent, in particular as a textile detergent.

Through the use of the detergent described herein, it is possible to achieve excellent cleaning performance, in particular against fatty, oily soiling. The cleaning performance is in particular also excellent at low temperatures. In this connection, the expression “low temperature” refers to the temperature in a process for washing textiles, usually in an automatic washing machine, that is 50° C. or less, preferably 40° C. or less, and particularly preferably 30° C. or less.

Furthermore, due to the use of a methyl ester-based surfactant system, the detergent described herein is advantageous compared to known detergents comprising surfactant systems based on linear alkylbenzene sulfonates (LAS) in terms of sustainability.

Moreover, the use of the surfactant system, as defined herein for improving the cleaning performance, in particular the cleaning performance on fatty, oily soiling, of a detergent, in particular a liquid detergent, is also an object of the present invention. The invention relates in particular to the use of a surfactant system for increasing the cleaning performance, in particular on fatty, oily soiling, of a detergent, in particular of a liquid detergent, wherein the surfactant system comprises:
a) 15 to 50 wt. %, preferably 25 to 35 wt. %, each based on the surfactant system, of at least one surfactant of formula R¹—CH(SO₃⁻X⁺)—C(═O)OCH₃ and/or
b) 15 to 50 wt. %, preferably 25 to 35 wt. %, each based on the surfactant system, of at least one surfactant of formula R²—C(═O)O-(AO)ₙ—CH₃,
where
R¹, R², independently of one another, denote a linear or branched, substituted or unsubstituted alkyl group having 2 to 20 carbon atoms, a linear or branched, substituted or unsubstituted aryl group having 6 to 22 carbon atoms, or a linear or branched, substituted or unsubstituted alkylaryl group having 6 to 22 carbon atoms,
AO denotes an ethylene oxide (EO) or propylene oxide (PO) grouping,
n denotes an integer from 1 to 50,
denotes a monovalent cation or the nth part of an n-valent cation.

Cleaning performance (cleaning power) within the scope of the invention shall be understood to mean the removal of one or more soils, in particular laundry soils, which are sensitive to bleach, sensitive to enzymes or sensitive to surfactants. The removal can be both metrologically detected and visually assessed by way of a lightening of the soils.

The agents can be detergents for textiles, carpets and rugs, or natural fibers. Within the scope of the invention, the detergents furthermore include auxiliary washing agents, which are metered to the actual detergent during the manual or machine-based textile washing process so as to achieve further action. Detergents within the scope of the invention also include textile pre- and after-treatment agents, which is to say agents with which the piece of laundry is brought in contact prior to the actual washing process, for example to partially loosen persistent soiling, and also agents that impart further desirable properties, such as a pleasant feel, crease resistance, or low static electricity, to the item to be washed in a step downstream from the actual textile washing process. The agents mentioned last include fabric softeners, for example.

The detergents described herein comprise at least one of the surfactants as described above.

Without being limited to this, it is assumed that the methyl ester surfactants used according to the invention, which spatially do not have a linear composition in terms of the structure, but have a “bend” in the molecule caused by the free electron pairs on the oxygen, form less densely packed and larger, more heterogeneous micelles than fatty alcohol ethoxylates (FAE), which have a linear composition. Due to their negative partial charge, the electron pairs on the oxygen additionally provide interaction sites both with the textile and with the dirt and can therefore retain/bind the dirt more effectively than FAEO or LAS.

All quantities indicated in connection with the components of the detergent described herein refer to wt. %, in each case based on the total weight of the detergent, unless indicated otherwise. Moreover, quantities that relate to at least one component always relate to the total amount of this type of component present in the detergent, unless explicitly indicated otherwise. This means that such quantities, for example in connection with “at least one nonionic surfactant,” refer to the total amount of nonionic surfactants present in the detergents.

“At least one,” as used herein, refers to 1 or more, for example 1, 2, 3, 4, 5, 6, 7, 8, 9, or more. In connection with components of the compositions described herein, this information does not refer to the absolute amount of molecules, but to the type of the component. “At least one nonionic surfactant” therefore signifies, for example, one or more different nonionic surfactants, which is to say one or more different types of nonionic surfactants. Together with quantities, the quantities refer to the total amount of the corresponding identified type of component, as already defined above.

The surfactant systems that are used in the described detergents, preferably liquid detergents, contain:
a) 15 to 50 wt. %, preferably 5 to 35 wt. %, each based on the surfactant system, of at least one surfactant of formula R¹—CH(SO₃⁻X⁺)—C(═O)OCH₃ and/or
b) 15 to 50 wt. %, preferably 25 to 35 wt. %, each based on the surfactant system, of at least one surfactant of formula R²—C(═O)O-(AO)ₙ—CH₃,
where
R¹, R², independently of one another, denote a linear or branched, substituted or unsubstituted alkyl group having 2 to 20 carbon atoms, a linear or branched, substituted or unsubstituted aryl group having 6 to 22 carbon atoms, or a linear or branched, substituted or unsubstituted alkylaryl group having 6 to 22 carbon atoms,
AO denotes an ethylene oxide (EO) or propylene oxide (PO) grouping,
n denotes an integer from 1 to 50, and
X⁺ denotes a monovalent cation or the nth part of an n-valent cation, preferably selected from alkali metal ions, NH₄⁺, 1/2Zn²⁺, 1/2Mg²⁺, 1/2Ca²⁺, and 1/2Mn²⁺, in particular from Na⁺ and K⁺, and particularly preferably Na⁺.

It is preferred according to the invention for the detergents in each case to contain at least one surfactant according to a) and at least one surfactant according to b).

In a further embodiment of the present invention, the AO in the surfactant of formula R²—C(═O)O-(AO)ₙ—CH₃ is ethylene oxide, and n denotes an integer from 1 to 50, preferably 8 to 25, particularly preferably 9 to 12, and in particular 10.

In a further embodiment of the present invention, the detergent, preferably the liquid detergent, contains the surfactant according to a) and the surfactant according to b) at a ratio of 2:1 to 1:2, and preferably at a ratio of 1:1.

The described surfactant systems containing the surfactants a) and/or b) are present in the detergent in different embodiments in amounts of 5 wt. % to 40 wt. %, preferably 10 wt. % to 30 wt. %, still more preferably approximately 18 wt. %, in each case based on the total weight of the detergent. Regardless of whether the detergent contains one or more of the above-defined surfactant systems, the quantities refer to the total amount of all surfactant systems present in the detergent.

In different embodiments, the detergent may contain further nonionic and/or further anionic surfactants.

For example, the surfactant may additionally comprise at least one alkylbenzene sulfonate. Such alkylbenzene sulfonates are preferably selected from linear or branched alkylbenzene sulfonates of formula

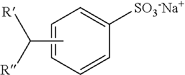

in which R′ and R″ independently are H or alkyl, and together contain 6 to 19, preferably 7 to 15, and in particular 9 to 13 carbon atoms. Sodium dodecylbenzenesulfonate is an especially particularly preferred representative. Such alkylbenzene sulfonates are preferably present in the detergent in amounts of 12.5 wt. % to 45 wt. %, based on the total weight of the surfactant system. Regardless of whether the detergent contains one or more of the above-defined alkylbenzene sulfonates, the quantities refer to the total amount of all alkylbenzene sulfonates present in the surfactant mixture. However, it is preferred that the detergent contains few or no alkylbenzene sulfonates, but that these are replaced with the MES that are used.

The detergent can furthermore contain alkyl ether sulfates. Suitable alkyl ether sulfates are compounds of formula

R³—O-(AO)ₙ—SO₃⁻X⁺

In this formula, R³ denotes a linear or branched, substituted or unsubstituted alkyl group, preferably a linear, unsubstituted alkyl group, and particularly preferably a fatty alcohol group. Preferred groups R³ are selected from decyl, undecyl, dodecyl, tridecyl, tetradecyl, pentadecyl, hexadecyl, heptadecyl, octadecyl, nonadecyl, eicosyl groups and the mixtures thereof, wherein representatives having an even number of carbon atoms are preferred. Particularly preferred groups R¹ are derived from C₁₂ to C₁₈ fatty alcohols, for example from coconut fatty alcohol, tallow fatty alcohol, lauryl, myristyl, cetyl or stearyl alcohol, or from C₁₀ to C₂₀ oxo alcohols.

In the above-described alkyl ether sulfates, AO denotes an ethylene oxide (EO) or propylene oxide (PO) grouping, preferably an ethylene oxide grouping. The subscript n denotes an integer from 1 to 50, preferably from 1 to 20, and in particular from 2 to 10. It is especially particularly preferred if n denotes the numbers 2, 3, 4, 5, 6, 7, or 8. X denotes a monovalent cation or the nth part of an n-valent cation, alkali metal ions being preferred, and among these Na⁺ or K⁺, Na⁺ being extremely preferred. Further cations X+ can be selected from NH₄⁺, 1/2Zn²⁺, 1/2Mg²⁺, 1/2Ca²⁺, 1/2Mn²⁺, and the mixtures thereof.

In different embodiments, the detergents contain an alkyl ether sulfate selected from fatty alcohol ether sulfates (FAEOS) of formula

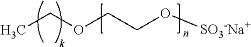

where k=11 to 19, n=2, 3, 4, 5, 6, 7 or 8. Especially particularly preferred representatives are Na—C₁₂₋₁₄ fatty alcohol ether sulfates comprising 2EO (k=11 to 13, n=2 in formula A-1). The degree of ethoxylation indicated represents a statistical average that can be an integer or a fractional number for a specific product. The degrees of alkoxylation indicated represent statistical averages that can correspond to an integer or a fractional number for a specific product. Preferred alkoxylates/ethoxylates exhibit a restricted distribution of homologs (narrow range ethoxylates, NRE). The above-defined alkyl ether sulfates are preferably present in the detergent in amounts of 12.5 wt. % to 50 wt. %, preferably 15 wt. % to 45 wt. %, and still more preferably 35 wt. % to 40 wt. %, in each case based on the surfactant mixture. Regardless of whether the detergent contains one or more of the above-defined alkyl ether sulfates, the quantities refer to the total amount of all alkyl ether sulfates present in the surfactant mixture.

The detergent can furthermore comprise at least one fatty alcohol alkoxylate. Preferred detergents contain at least one fatty alcohol alkoxylate of formula

R⁴—O-(AO)ₘ⁻H,

where
R⁴ denotes a linear or branched, substituted or unsubstituted alkyl group,
AO denotes an ethylene oxide (EO) or propylene oxide (PO) grouping, and
m denotes integers from 1 to 50.

In the above-mentioned formula, R′ denotes a linear or branched, substituted or unsubstituted alkyl group, preferably a linear, unsubstituted alkyl group, and particularly preferably a fatty alcohol group. Preferred groups R² are selected from decyl, undecyl, dodecyl, tridecyl, tetradecyl, pentadecyl, hexadecyl, heptadecyl, octadecyl, nonadecyl, eicosyl groups and the mixtures thereof, wherein representatives having an even number of carbon atoms are preferred. Particularly preferred groups R² are derived from C₁₂ to C₁₈ fatty alcohols, for example from coconut fatty alcohol, tallow fatty alcohol, lauryl, myristyl, cetyl or stearyl alcohol, or from C₁₀ to C₂₀ oxo alcohols.

In the fatty alcohol alkoxylates, AO denotes an ethylene oxide (EO) or propylene oxide (PO) grouping, preferably an ethylene oxide grouping. The subscript m denotes an integer from 1 to 50, preferably from 1 to 20, and in particular from 2 to 10. It is especially particularly preferred if m denotes the numbers 2, 3, 4, 5, 6, 7, or 8.

In summary, particularly preferred fatty alcohol alkoxylates are those of formula

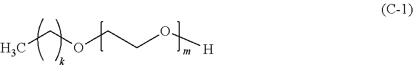

where k=11 to 19, m=2, 3, 4, 5, 6, 7 or 8. Especially particularly preferred representatives are C₁₂₋₁₈ fatty alcohols including 7 EO (k=11 to 17, m=7 in formula C-1). The above-described fatty alcohol alkoxylates are preferably present in the detergent in amounts of 25 wt. % to 55 wt. %, based on the total weight of the surfactant mixture. Regardless of whether the detergent contains one or more of the above-defined fatty alcohol alkoxylates, the quantities refer to the total amount of all fatty alcohol alkoxylates present in the surfactant mixture.

It has been found to be advantageous, in particular for the cold washing performance, if the detergents additionally contain soap(s). Preferred detergents are thus characterized by comprising—based on the weight thereof—0.25 to 15 wt. %, preferably 0.5 to 12.5 wt. %, more preferably 1 to 10 wt. %, still more preferably 1.5 to 7.5 wt. %, and in particular 2 to 6 wt. % soap(s). Particularly preferred are soaps of C₁₂ to C₁₈ fatty acids.

Additionally, the detergent can contain other ingredients that further improve the application-related and/or aesthetic properties of the detergent. Within the scope of the present invention, the detergent preferably additionally contains one or more substances from the group consisting of enzymes, bleaching agents, complexing agents, builders, electrolytes, non-aqueous solvents, pH-setting agents, perfumes, perfume carriers, fluorescent agents, dyes, hydrotopics, foam inhibitors, silicone oils, anti-redeposition agents, graying inhibitors, shrinkage preventers, anti-wrinkle agents, color transfer inhibitors, antimicrobial active agents, germicides, fungicides, antioxidants, preservatives, corrosion inhibitors, antistatic agents, bittering agents, ironing aids, repellents and impregnating agents, swelling and anti-slip agents, softening components, and UV absorbers.

The detergent preferably contains at least one enzyme. In principle, all enzymes that are established in the prior art for these purposes can be used in this regard. Preferably, this is one or more enzymes that are able to develop a catalytic activity in a detergent, in particular a protease, an amylase, a lipase, cellulase, hemicellulase, mannanase, pectinolytic enzyme, tannase, xylanase, xanthanase, β-glucosidase, carrageenase, perhydrolase, oxidase, oxidoreductase, and the mixtures thereof. Preferred hydrolytic enzymes comprise in particular proteases, amylases, in particular α-amylases, cellulases, lipases, hemicellulases, in particular pectinases, mannanases, β-glucanases, and the mixtures thereof. Proteases, amylases and/or lipases and the mixtures thereof are particularly preferred, and proteases are especially particularly preferred. These enzymes are, in principle, of natural origin; proceeding from the natural molecules, improved variants are available for use in detergents and are used in correspondingly preferred fashion.

The enzymes to be used can furthermore be formulated together with by-products, such as from fermentation, or with stabilizers.

All substances that destroy or absorb dyes by way of oxidation, reduction or adsorption and thereby remove color from materials may be used as bleaching agents. These include, among other things, hypohalogenite-containing bleaching agents, hydrogen peroxide, perborate, percarbonate, peracetic acid, diperoxyazelaic acid, diperoxododecanedioic acid, and oxidative enzyme systems.

In particular silicates, aluminum silicates (in particular zeolites), carbonates, salts of organic di- and polycarboxylic acids, and mixtures of these substances, shall be mentioned as builders that may be present in the detergent.

Organic builders that may be present in the detergent are, for example, the polycarboxylic acids that can be used in the form of the sodium salts thereof, wherein polycarboxylic acids shall be understood to mean those carboxylic acids which carry more than one acid function. These include, for example, citric acid, adipic acid, succinic acid, glutaric acid, malic acid, tartaric acid, maleic acid, fumaric acid, saccharic acids, aminocarboxylic acids, and mixtures thereof. Preferred salts are the salts of polycarboxylic acids such as citric acid, adipic acid, succinic acid, glutaric acid, tartaric acid, saccharic acids, and mixtures thereof.

Moreover, polymeric polycarboxulates are suitable builders. These are, for example, the alkali metal salts of polyacrylic acid or of polymethacrylic acid, for example those having a relative molar mass from 600 to 750,000 g/mol.

Suitable polymers are in particular polyacrylates, which preferably have a molar mass from 1,000 to 15,000 g/mol. Due to superior solubility, short-chain polyacrylates having molar masses from 1,000 to 10,000 g/mol, and particularly preferably from 1,000 to 5,000 g/mol, may in turn be preferred from this group.

Also suitable are copolymeric polycarboxylates, in particular those of acrylic acid with methacrylic acid, and of acrylic acid or methacrylic acid with maleic acid. To improve water solubility, the polymers can also contain allyl sulfonic acids, such as allyloxybenzene sulfonic acid and methallyl sulfonic acid, as a monomer.

Soluble builders, such as citric acid, or acrylic polymers having a molar mass of 1,000 to 5,000 gmol⁻¹ are preferred in liquid detergents.

Preferred detergents are liquid and preferably contain water as the primary solvent. It is preferred for the detergent to contain more than 5 wt. %, preferably more than 15 wt. %, and particularly preferably more than 25 wt. % water, in each case based on the total amount of detergent. Particularly preferred liquid detergents comprise 5 to 90 wt. %, preferably 10 to 85 wt. %, preferably 25 to 75 wt. %, and in particular 35 to 65 wt. % water, based on the weight of the liquid detergents. Alternatively, the detergents may be detergents containing little or no water, wherein the water content in a preferred embodiment is less than 10% by weight, and more preferably less than 8% by weight, in each case based on the total liquid detergent.

Moreover, non-aqueous solvents may be added to the detergent. Suitable non-aqueous solvents comprise monohydric or polyhydric alcohols, alkanolamines or glycol ethers, provided they are miscible with water in the described concentration range.

The solvents are preferably selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxy butanol, propylene glycol t-butyl ether, di-n-octyl ether, and mixtures of these solvents. However, it is preferred for the detergent to contain an alcohol, in particular ethanol and/or glycerol, in amounts between 0.5 and 5 wt. %, based on the total detergent.

Methods for cleaning textiles are generally characterized in that, in multiple method steps, different substances with cleaning action are applied to the product to be cleaned and washed off following the application time, or that the product to be cleaned is treated in another manner with a detergent or a solution of this agent.

In the described washing method, temperatures of 50° C. or less, 40° C. or less, 30° C. or less, or 20° C. or less are used in different embodiments. This temperature information refers to the temperatures used in the washing steps.

As was already described above, the invention also relates to the use of at least one surfactant system based on methyl esters, in particular MEE, MES or mixtures thereof, for improving the cleaning performance of a detergent, in particular on fatty soiling. The surfactant system is that which is defined above. In particular, the surfactant systems disclosed above as preferred embodiments, in particular the combination of MEE and MES, particularly preferably at a ratio of 1:1, are likewise preferred for the described use. The detergent is preferably a liquid detergent and/or contains the individual surfactant components in the amounts and ratios disclosed above in connection with the disclosed detergent.

All content, subject matter and embodiments that are described for the detergents can also be applied to the washing method and the use, and vice versa.

The detergents described herein, and in particular the described liquid detergents containing little or no water, can be filled into a water-soluble casing and can thus be an integral part of a water-soluble packaging. If the detergent is packaged in a water-soluble casing, it is preferred that the water content is less than 10 wt. %, based on the total detergent, and that anionic surfactants, if present, are present in the form of the ammonium salts thereof.

Contrary to bases such as NaOH or KOH, the neutralization by way of amines does not result in the formation of water. In this way, it is possible to produce detergents that contain little water and are suitable directly for use in water-soluble casings.

A water-soluble packaging contains a water-soluble casing in addition to the detergent. The water-soluble casing is preferably formed by a water-soluble film material.

Such water-soluble packagings can be produced using either vertical form fill sealing (VFFS) methods or thermoforming methods.

The thermoforming method generally includes forming a first layer from a water-soluble film material so as to create bulges for receiving a composition therein, filling the composition into the bulges, covering the bulges that are filled with the composition with a second layer made of a water-soluble film material, and sealing the first and second layers together, at least around the bulges.

The water-soluble casing is preferably formed of a water-soluble film material selected from the group consisting of polymers or polymer mixtures. The casing can be formed of one layer, or of two or more layers of the water-soluble film material. The water-soluble film material of the first layer and that of the further layers, if such are present, can be the same or different.

The water-soluble packaging, comprising the detergent and the water-soluble casing, can comprise one or more chambers. The liquid detergent can be present in one or more chambers, if present, of the water-soluble casing. The amount of liquid detergent preferably corresponds to the full dose, or half the dose, that is required for one washing operation.

It is preferable for the water-soluble casing to comprise polyvinyl alcohol or a polyvinyl alcohol copolymer.

Suitable water-soluble films for producing the water-soluble casing are preferably based on a polyvinyl alcohol, or a polyvinyl alcohol copolymer, having a molecular weight in the range from 10,000 to 1,000,000 gmol¹, preferably from 20,000 to 500,000 gmol¹, particularly preferably from 30,000 to 100,000 gmol⁻¹, and in particular from 40,000 to 80,000 gmol⁻¹.

Additionally, polymers selected from the group consisting of acrylic acid containing polymers, polyacrylamides, oxazoline polymers, polystyrene sulfonates, polyurethanes, polyesters, polyethers, polylactic acid and/or mixtures of the above polymers can be added to a film material that is suitable for producing the water-soluble casing.

In addition to vinyl alcohol, preferred polyvinyl alcohol copolymers comprise dicarboxylic acids as further monomers. Suitable dicarboxylic acids are itaconic acid, malonic acid, succinic acid and mixtures thereof, itaconic acid being preferred.

Likewise, preferred polyvinyl alcohol copolymers comprise an ethylenically unsaturated carboxylic acid, the salt thereof, or the ester thereof, in addition to vinyl alcohol. In addition to vinyl alcohol, such polyvinyl alcohol copolymers particularly preferably comprise acrylic acid, methacrylic acid, acrylic acid esters, methacrylic acid esters or mixtures thereof.

Suitable water-soluble films for use in the casings of the water-soluble packagings according to the invention are films sold by MonoSol LLC, for example, by the designation M8630, C8400 or M8900. Other suitable films include films by the designation Solublon® PT, Solublon® GA, Solublon® KC or Solublon® KL from Aicello Chemical Europe GmbH, or the VF-HP films from Kuraray.

The water-soluble packagings can have a substantially dimensionally stable spherical or pillow-shaped design having a circular, elliptic, square or rectangular basic shape.

The water-soluble packaging can comprise one or more chambers for storing one or more agents. If the water-soluble packaging comprises two or more chambers, at least one chamber contains a liquid detergent. The remaining chambers can each contain a solid or a liquid detergent.

### EXAMPLES

### Example 1

### Detergent Formulations Used

Table 1 shows an exemplary standard detergent, which was used for reference in the experiments that were conducted. All quantities are listed in wt. % active substance (AS) based on the total weight of the composition, unless otherwise indicated.

TABLE 1

| | A (Reference) |
|---|---|
| C₉₋₁₃ alkylbenzene sulfonic acid | 5.5 |
| C₁₂₋₁₈ FAEO including 7 EO | 5.5 |
| C₁₂₋₁₄ FAEOS including 2 EO | 7 |
| C₁₂₋₁₈ fatty acid | 3 |
| Citric acid | 2 |
| Sodium hydroxide | 2 |
| Boric acid | 1 |
| Enzymes | X |
| Perfume | X |
| Propanediol | 2.5 |
| Propylene glycol/glycerol | 2 |
| Ethanol | 2 |
| Phosponic acid | 1 |
| Water | up to 100 |

The tested novel surfactant formulations were obtained by replacing the existing surfactants, wherein the ratio of anionic to nonionic surfactants was maintained, and LAS was replaced with MES and FAEO with MEE.

The following combinations were tested:

TABLE 2
Tested surfactant systems. All information in wt. % is based on the detergent.

| Surfactant | | | FA | | MEE | MEE | |
|---|---|---|---|---|---|---|---|
| total | LAS | FAEOS | 7EO | MES | 10 EO | 12 EO | |
| 18 | | 7 | 5.5 | 5.5 | | | MES |
| | | | | | | | instead |
| | | | | | | | of LAS |
| 18 | 5.5 | 7 | | | | 5.5 | Long MEE |
| | | | | | | | instead |
| | | | | | | | of FAEO |
| 18 | 5.5 | 7 | | | 5.5 | | Short MEE |
| | | | | | | | instead |
| | | | | | | | of FAEO |
| 18 | | 7 | | 5.5 | | 5.5 | MES + |
| | | | | | | | long MEE |
| 18 | | 7 | | 5.5 | 5.5 | | MES + |
| | | | | | | | short MEE |
| | Maranil | Texapon | Dehydol | Palfonate, | Surfonic | Surfonic ME | |
| | DBS, BASF | NSO, BASF | LT7, BASF | KLK Oleo | ME400, | 530-PS | |
| | | | | | Huntsman | Huntsman | |
| | | | | | Coco | Palm | |

Reference: 5.5% LAS, 7% FAEOS, 5.5% FAEO.

### Example 2

### Improved Stain Removal

For the washing tests, purchased items containing fatty soiling were washed in a miniaturized washing test, then rinsed, dried, and subsequently the remission values of the same were measured by way of spectrophotometry (Minolta CR400-1). The detergent from Table 1 was used for reference and compared to the surfactant mixtures according to the invention. Washing temperature: 25° C., washing duration: 1 h, liquor volume: 50 ml, dosage 0.21 g, 5-fold determination.

Standardized greasy soiling was selected as the test soiling.

The indicated values show the differences in the remission values compared to the standard detergent and the measuring uncertainty in the 5-fold determination. The greater the remission value difference, the better the stain removal.

Formula for measuring uncertainty (MU):

$$\frac{\sqrt{{σ}_{1}^{2} + {σ}_{2}^{2}}}{\sqrt{5}}$$

σ1=standard deviation detergent
σ2=standard deviation detergent containing novel surfactant fixture

TABLE 2

| Grease soiling | MU | |
|---|---|---|
| −0.3 | 2.1 | MEE instead of FAEO |
| +3.0 | 0.8 | MES + short MEE |

Line 1: The use of MEE alone did not result in any improvement.
Line 2: Compared to the use of MEE in combination with LAS (line), the combination of MEE and MES resulted in an improvement in the performance. The combination of the two methyl ester surfactants thus achieved optimized cleaning power, in particular with respect to different grease soils.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A detergent having a surfactant system that comprises:
a1) 15 to 50 wt. %, each based on the surfactant system, of at least one surfactant of formula R¹—CH(SO₃⁻X⁺)—C(═O)OCH₃ and/or
b1) 15 to 50 wt. %, each based on the surfactant system, of at least one surfactant of formula R²—C(═O)O-(AO)ₙ—CH₃,
where
R¹, R², independently of one another, denote a linear or branched, substituted or unsubstituted alkyl group having 2 to 20 carbon atoms, a linear or branched, substituted or unsubstituted aryl group having 6 to 22 carbon atoms, or a linear or branched, substituted or unsubstituted alkylaryl group having 6 to 22 carbon atoms,
AO denotes an ethylene oxide (EO) or propylene oxide (PO) grouping,
n denotes an integer from 1 to 50,
X⁺ denotes a monovalent cation or the nth part of an n-valent cation.

2. The detergent, according to claim 1, wherein AO in the surfactant according to b) is ethylene oxide, and n denotes 1 to 50.

3. The detergent according to claim 1, wherein the surfactant according to a) and the surfactant according to b) are present at a ratio of 2:1 to 1:2.

4. The detergent, according to claim 1, wherein the surfactant system furthermore comprises (i) 12.5 to 45 wt. % alkylbenzene sulfonate(s) and/or (ii) 25 to 55 wt. % fatty alcohol ethoxylate(s), each based on the surfactant system.

5. The detergent, according to claim 4, wherein the surfactant system furthermore comprises at least one fatty alcohol ethoxylate having 2 to 15 EO.

6. The detergent, according to claim 1, wherein the surfactant system is present in amounts of 5 to 40 wt. %, based on the detergent.

7. The detergent, according to claim 1, characterized in that the detergent furthermore comprises at least one further component selected from the group consisting of enzymes, bleaching agents, complexing agents, builders, electrolytes, non-aqueous solvents, pH-setting agents, perfumes, perfume carriers, fluorescent agents, dyes, hydrotopics, foam inhibitors, silicone oils, anti-redeposition agents, graying inhibitors, shrinkage preventers, anti-wrinkle agents, color transfer inhibitors, antimicrobial active agents, germicides, fungicides, antioxidants, preservatives, corrosion inhibitors, antistatic agents, bittering agents, ironing aids, repellents and impregnating agents, swelling and anti-slip agents, softening components, and UV absorbers.

8. The detergent, according to claim 1, characterized in that the detergent is present in liquid form in a water-soluble casing made of a water-soluble film material, the water-soluble film material comprising polyvinyl alcohol or a polyvinyl alcohol copolymer.

9. A washing method, comprising the following method steps:
a) providing a washing solution comprising a detergent, according to claim 1; and
b) bringing a textile in contact with the washing solution.
